(19) United States
(12) Patent Application Publication
(10) Pub. No.: US 2018/0349846 A1
(43) Pub. Date: Dec. 6, 2018

(54) Pre-Authorized Return of Items in a Logistics Network

(71) Applicant: United Parcel Service of America, Inc., Atlanta, GA (US)

(72) Inventors: Adam Sever, Atlanta, GA (US); Michael Petrik, Atlanta, GA (US); Patrick Stewart, Milton, GA (US)

(21) Appl. No.: 15/994,736

(22) Filed: May 31, 2018

Related U.S. Application Data
(60) Provisional application No. 62/513,086, filed on May 31, 2017.

(51) Int. Cl. G06Q 10/08; G06K 7/10; G06K 19/06; G06Q 30/06

(52) U.S. Cl. CPC G06Q 10/0837; G06Q 30/0641; G06K 19/06009; G06K 7/10861

(57) ABSTRACT

Methods and systems for generating, facilitating, and providing pre-authorized return of delivered items in a logistics network. A shipper may designate one or more items for delivery to a recipient using a logistics provider. The shipper may designate the items as pre-authorized for return with the logistics provider. The pre-authorized return status may be established or determined based on a unique identifier associated with the shipper and/or an identifier associated with the item, which may be linked with shipper-designated return parameters. A recipient may initiate a return of an item with the logistics provider based on the pre-authorized return status. The unique identifier and/or item identifier may be used to determine details of the return and provide visibility to the shipper and/or to the recipient making the return. A recipient may initiate a return through a return portal.

### CROSS-REFERENCE TO RELATED APPLICATIONS AND PRIORITY CLAIM

This Non-Provisional Patent Application claims priority benefit of co-pending U.S. Provisional Patent Application No. 62/513,086, filed May 31, 2017, titled “Pre-Authorized Return of Parcels in a Logistics Network,” which is incorporated herein by reference in the entirety.

### TECHNICAL FIELD

The field relates to delivery and return of items in a logistics network.

### BACKGROUND

Sending and delivering items using a logistics provider often involves using delivery information that allows the items to be routed to a desired location. In certain circumstances, a shipper sending items to a recipient via a logistics provider may wish to provide an option for returning at least some of the items for certain reasons. Providing an option for returning delivered items can provide greater consumer confidence in e-commerce transactions, and as a result, facilitate a higher volume of transactions. A return of delivered items can require additional delivery information that is used to route the items back to the shipper or to another return location. In this sense, coordinating the return of items to a desired return location may create additional logistical burdens for a recipient, a shipper, and/or a logistics provider.

Furthermore, conventional methods and systems for initiating and managing returns present logistical burdens. For example, items being returned are often sent and tracked separately from an original delivery. Further, facilitating a return may require additional communications between a recipient and a shipper that creates additional delays and expenditures of time and resources. Even further, a recipient of items may not easily be able to access return policies and/or create return labels using the same tools that were used to track the original delivery of the items. Conventional methods and systems may also result in some items being returned to locations that are not appropriate for a particular return.

### SUMMARY

This summary is provided to introduce a selection of concepts in a simplified form that are further described below in the detailed description section of this disclosure. This summary is not intended to be used to identify key or essential features of the claimed subject matter, nor is it intended to be used as an aid in isolation for determining the scope of the claimed subject matter.

In brief, and at a high level, this disclosure describes, among other things, systems and methods for providing pre-authorized return of items in a logistics network. In some embodiments, a shipper may designate one or more items for delivery to a recipient using a logistics provider (e.g., a logistics company or organization that stores, transports, delivers, and/or returns items). The shipper may designate the items as pre-authorized for return via the logistics provider. The pre-authorized return status may be established or identified based on a unique identifier associated with the shipper (e.g., an account number with the logistics provider) and/or based on an identifier associated with the item (e.g., a Stock Keeping Unit (SKU) number for the item). As an example, once an item has been delivered, a recipient may initiate a return of the item via the logistics provider based on the pre-authorized return status of the item. The unique identifier and/or item identifier may be used to determine shipper-designated parameters for the return (e.g., a service level for the return, information required from the recipient for the return, a destination for the return, etc.) and may be used for linking a shipping number (e.g., tracking number generated by the logistics provider) used for the initial delivery with a shipping number used for the return to provide visibility to the shipper and/or to the recipient making the return. This visibility may be provided through a returns portal accessed via the logistics provider's website. The unique identifier may also be used for billing the shipper for the return. Further, the recipient may initiate the return through the aforementioned return portal, which then allows the recipient to access a return label electronically for printing, sending, and/or presenting at a shipping location of the logistics provider.

Embodiments of the present technology address and improve the technical burdens present with conventional return systems and also improve the process of generating and using a return shipping label. For example, by reducing the number of webpages or locations that a user must visit in order to obtain a return shipping label for the return of a delivered item, computer and human resources may be saved and efficiency increased. The process of accurately returning an item may also be improved. Additionally, the technical and/or logistical burdens present when a recipient does not have access to a printer to print a shipping label may be improved by providing an electronic return label to the recipient, which may be downloaded, sent via electronic protocol, and/or saved for later access and printing. To further streamline the returns process, a recipient may utilize a returns portal accessed via a website (e.g., of the logistics provider) to identify a shipping location operated by the logistics provider that includes a mobile barcode scanner that is equipped and adapted to scan the electronic return label on the recipient's mobile device, generating a physical return label. Therefore, by providing a pre-authorized returns process and system as described herein, the technical and/or workflow burdens associated with returning items delivered by a logistics provider may be improved and resources saved.

In one embodiment of the present technology, a system that enables pre-authorized return of items by a logistics provider is disclosed. The system comprises one or more computing devices connected to a network, the one or more computing devices comprising one or more processors and one or more non-transitory computer-readable media having computer-executable instructions stored thereon that, when executed by the one or more processors, perform a method of providing pre-authorized returns. The method comprises generating a returns portal for display on a user-interface of a device, the returns portal comprising information about an item delivered to a recipient via the logistics provider and at least one return policy of a shipper from which the item originated, receiving a request to initiate a physical return of the item via the user-interface, determining, based on a unique identifier associated with the shipper, that the item is pre-authorized for return via the logistics provider, and following the determination that the item is pre-authorized for return, generating one or more selectable return inputs for display on the user-interface of the device. The one or more selectable return inputs may be designated by the shipper and may be associated with the unique identifier. The method further comprises receiving inputs for each of the one or more selectable return inputs via the user interface, initiating a return of the item following a determination that the inputs for the one or more selectable return inputs satisfy the requirements of the at least one return policy, and generating a scannable return label for display on the user-interface, the scannable return label including return information associated with the item and the shipper.

In another embodiment of the present technology, a computer-implemented method for enabling pre-authorized return of items by a logistics provider is disclosed. The method comprises generating a returns portal for display on a user-interface of a device, the returns portal comprising information about an item delivered to the recipient via the logistics provider and at least one return policy of a shipper from which the item originated, receiving, via the user-interface, a request to initiate a physical return of the item, determining, based on a unique identifier associated with the shipper, that the item is pre-authorized for return via the logistics provider, and following the determination that the item is pre-authorized for return, generating one or more selectable return inputs for display on the user-interface of the device. The one or more selectable return inputs may be designated by the shipper and may be associated with the unique identifier. The method further comprises receiving, via the user interface, inputs for each of the one or more selectable return inputs, initiating a return of the item following a determination that the inputs satisfy the requirements of the at least one return policy, and generating a scannable return label for display on the user-interface, the scannable return label including return information associated with the item and the shipper.

In another embodiment of the present technology, one or more non-transitory computer-readable media having computer-executable instructions stored thereon are provided that, when executed by one or more processors of a computing device, perform a method that enables pre-authorized return of items by a logistics provider. The method comprises generating a returns portal for display on a user-interface of a device, the returns portal comprising information about an item delivered to the recipient via the logistics provider and at least one return policy of a shipper from which the item originated, receiving, via the user-interface, a request to initiate a physical return of the item, determining, based on a unique identifier associated with the shipper, that the item is pre-authorized for return via the logistics provider, and following the determination that the item is pre-authorized for return, generating one or more selectable return inputs for display on the user-interface of the device. The one or more selectable return inputs may be designated by the shipper and may be associated with the unique identifier. The method further comprises receiving, via the user interface, inputs for each of the one or more selectable return inputs, initiating, based on the unique identifier, the inputs, and the at least one return policy, a return of the item, and generating a scannable return label for display on the user-interface, the scannable return label including return information associated with the item and the shipper.

The term “item” as used herein is to be interpreted broadly to include any items being shipped, including those shipped in one or multiple packages, bags, containers, loads, crates, pallets, drums, and the like, and/or similar words used interchangeably herein.

### BRIEF DESCRIPTION OF THE DRAWINGS

Embodiments of the present technology that relate to enabling pre-authorized return of items in a logistics network are described in detail herein with reference to the attached drawing figures, in which like numerals refer to like elements, wherein:

FIG. 1 is a block diagram of an example computing system suitable for providing pre-authorized return of items in a logistics network, in accordance with an embodiment of the present technology;

FIG. 2 depicts a diagram of a system that enables pre-authorized return of items via a logistics provider, in accordance with an embodiment of the present technology;

FIG. 3 depicts a flowchart of an example process for providing pre-authorized return of items via a logistics provider, in accordance with an embodiment of the present technology;

FIG. 4 depicts an example webpage of a return portal used for initiating pre-authorized returns for items delivered via a logistics provider, in accordance with an embodiment of the present technology;

FIG. 5 depicts additional webpages or portions thereof of a return portal used for providing pre-authorized return of items via a logistics provider, in accordance with an embodiment of the present technology;

FIG. 6 depicts a tracking table configured to support pre-authorized return of items via a logistics provider, in accordance with an embodiment of the present technology;

FIG. 7 depicts a calendar display page that provides information related to items delivered by a logistics provider, in accordance with an embodiment of the present technology;

FIG. 8 depicts an expanded presentation of data associated with an item from the calendar display page shown in FIG. 7, in accordance with an embodiment of the present technology;

FIG. 9 depicts a webpage providing shipping details for delivered items with an option for initiating a pre-authorized return through a logistics provider, in accordance with an embodiment of the present technology;

FIG. 10 depicts the shipping details webpage of FIG. 9 after a return option has been selected for a shipment, in accordance with an embodiment of the present technology;

FIG. 11 depicts a shipment management webpage that includes an option to initiate a pre-authorized return of an item associated with a delivered shipment, in accordance with an embodiment of the present technology;

FIG. 12 depicts a webpage that provides a list of shipping locations of a logistics provider that can be used to facilitate a pre-authorized return, accessed through a returns portal, in accordance with an embodiment of the present technology;

FIG. 13 depicts another webpage that provides information about a particular shipping location of a logistics provider, accessed through a returns portal, in accordance with an embodiment of the present technology;

FIG. 14 depicts a user-interface accessed through a returns portal that provides a display that allows a shipper to control parameters of the shipper's pre-authorized returns, in accordance with an embodiment of the present technology;

FIG. 15 depicts another display of the user-interface that allows a shipper to establish parameters of the shipper's pre-authorized returns, in accordance with an embodiment of the present technology;

FIG. 16 depicts another display of the user-interface that allows a shipper to establish parameters of the shipper's pre-authorized returns, in accordance with an embodiment of the present technology;

FIG. 17 depicts another display of the user-interface that allows a shipper to establish parameters of the shipper's pre-authorized returns, in accordance with an embodiment of the present technology;

FIG. 18 depicts a system and user-interface display that can be used by a shipper to establish a pre-authorized returns process with a logistics provider, in accordance with an embodiment of the present technology;

FIG. 19 depicts a block diagram of an example process for providing pre-authorized return of items via a logistics provider, in accordance with an embodiment of the present technology; and

FIG. 20 depicts an example system suitable for supporting pre-authorized return of items via a logistics provider, in accordance with an embodiment of the present technology.

### DETAILED DESCRIPTION

The subject matter of the present disclosure is described with specificity herein to meet statutory requirements. However, the description itself is not intended to limit the scope of the technology. Rather, the claimed subject matter might be embodied in other ways, to include different steps, or combinations of steps, similar to the ones described in this disclosure, and in conjunction with other present or future technologies. Moreover, although the terms “step” or “block” may be used herein to describe different elements of methods employed, the terms should not be interpreted as implying any particular order among or between such steps or blocks unless the order of individual steps or blocks is explicitly described and required.

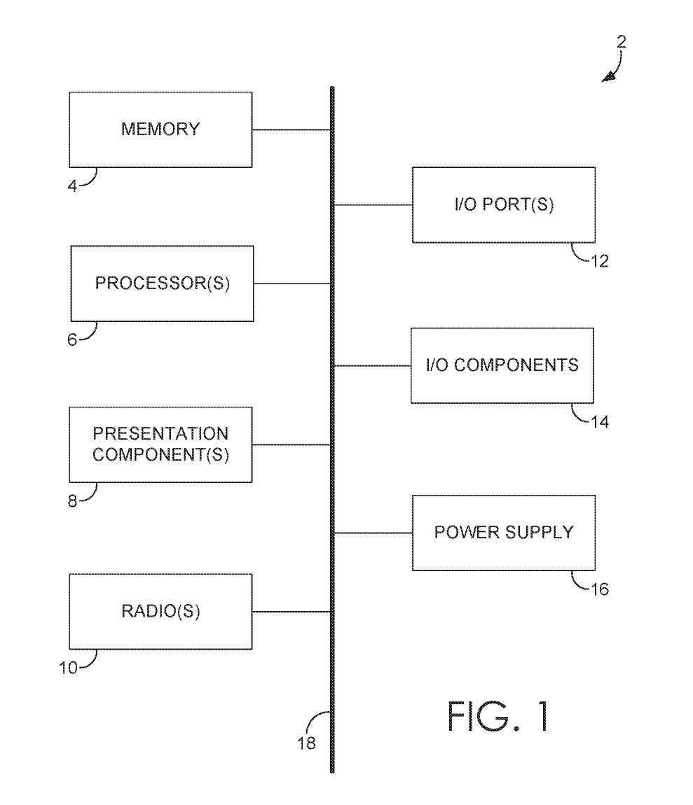

At a high level, this disclosure describes methods and systems for providing pre-authorized return of items delivered by a logistics provider. The systems and methods described herein may utilize a returns portal, which may be accessed through a logistics provider's website, and a unique identifier associated with a shipper of an item to generate a return label, including, in some embodiments, an electronic return label. Example methods, systems, and network architectures for providing such pre-authorized returns are described below with reference to FIGS. 1-20.

The subject matter hereof may be provided as, among other things, a method, a system, and/or a computer-program product. Accordingly, aspects herein may take the form of hardware, or may be a combination of software and hardware. A computer-program that includes computer-useable instructions embodied on one or more computer-readable media may also be used. The subject matter of the present disclosure may further be implemented as hard-coded into the mechanical design of computing components and/or may be built into a system enabled to provide pre-authorized return of items via a logistics provider.

Computer-readable media may include volatile media, non-volatile media, removable media, and non-removable media, and may also include media readable by a database, a switch, and/or various other network devices. Network switches, routers, and related components are conventional in nature, as are methods of communicating with the same, and thus, further elaboration is not provided here. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and/or other data representations. Computer storage media may include, but is not limited to, RAM, ROM, EEPROM, flash memory or other memory technology, CD-ROM, digital versatile discs (DVD), holographic media or other optical disc storage, magnetic cassettes, magnetic tape, magnetic disk storage, solid state storage drives, and other storage devices. These memory components may store data momentarily, temporarily, and/or permanently, and are not limited to the examples provided herein.

Pre-Authorized Returns in a Logistics Network

In one embodiment of the present technology, a shipper may have a unique identifier with a logistics provider that allows the shipper to designate items delivered by the logistics provider as pre-authorized for return to the shipper or to another location. By pre-authorizing returns through the logistics provider, the need for including pre-printed return labels with shipped items or having return-specific interactions between recipients and shippers of items may be reduced or eliminated. Additionally, the pre-authorized return designation may allow for the return of the items by the recipient based on parameters established by the shipper with the logistics provider. Furthermore, a recipient, upon initiating a return, may access, retrieve, and/or generate a return shipping label in electronic form for use in shipping the items to a return location (e.g., the shipper's location or another location). The return label may include delivery information for directing the items back to the shipper or to another location selected by the shipper (e.g., a repair facility, a re-stocking facility, etc.). In some embodiments, both a shipper and a recipient can track return delivery status using a returns portal that is accessible through the logistics provider (e.g., via a webpage of the logistics provider's website that provides a user/shipper with an appropriate user-interface).

Return Portals for Pre-Authorized Returns

In a further embodiment of the present technology, a returns portal provided via a logistics provider's website is disclosed. The portal may allow shippers to establish, configure, maintain, and/or make available to others the shipper's policies/parameters/criteria for pre-authorized returns via the logistics provider. The portal also allows the shippers to link selected return parameters with a unique identifier (e.g., an account number the shipper has established with the logistics provider). The unique identifier can then be used for designating items delivered by the logistics provider as pre-authorized for returns. A variety of return parameters may be configurable by the shipper via the portal including, for example, a maximum allowable time period for making a pre-authorized return, a service level of returns (e.g., shipping speed, ground or air, etc.), information required from recipients to initiate a return (e.g., a reason for the return, etc.) and/or other return parameters. For example, one parameter that may be configurable by a shipper through the returns portal may be a time period during which a return label may be accessed by a recipient to enable a pre-authorized return. The time period parameter may be established, for example, as 30, 60, 90, or 180 days from the delivery date of the item being returned. The shipper may also establish, through the returns portal, a parameter that requires and/or solicits a reason for return of the item from the recipient, and/or that requires or solicits comments from the recipient related to the return. For example, a shipper may require that a recipient making a return indicate if the return is made because an item is damaged, an item is defective, a delivery date was missed, incorrect items were shipped, lower prices are available, or other reasons.

Additionally, a shipper may establish parameters for returns through the return portal that require information from recipients about the item(s) being returned to provide a more effective and accurate return process. For example, the information may include item weight (e.g., to provide appropriate logistics for transferring the items and/or to assist in determining or distinguishing the number or type of items in the return), item dimensions, number of items being returned, and/or any other information about the items, in addition to comments and/or feedback from the recipient. The returns portal can also be used to provide visibility for the returns process (e.g., allowing a shipper and/or recipient returning an item to access the location and status of the item in the return transit).

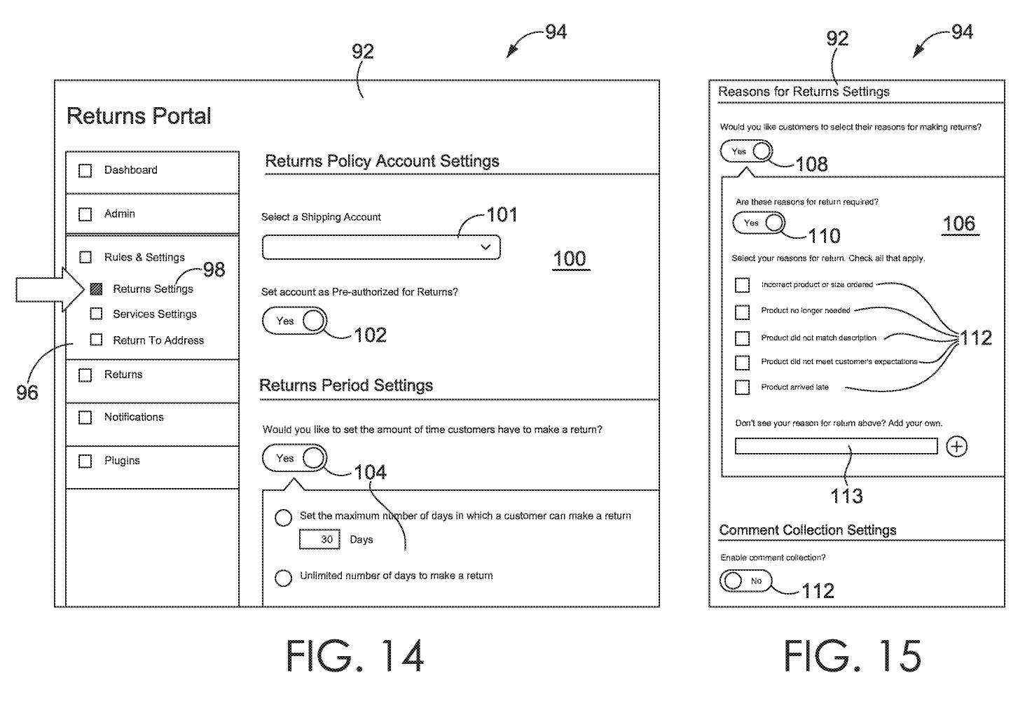

FIGS. 14-16 depict different displays provided by a user-interface of a return portal, accessed through a webpage of a logistics provider's website, that allow shippers to associate return parameters with a unique identifier (e.g., an account number the shipper has with the logistics provider), so that items delivered by the logistics provider can be linked with the unique identifier and therefore be pre-authorized for returns with the selected parameters discussed above.

### Example Return Labels and Generation Thereof

In another embodiment of the present technology, a recipient wanting to return an item delivered by a logistics provider that is designated as pre-authorized for return may have access to different return label options. These return label options may be presented in the return portal discussed herein and above. Further, during a return, an electronic return label (“ERL”) or mobile barcode may be generated that includes return delivery information for the items being returned (e.g., a shipping barcode or other machine-readable indicia). The ERL or mobile barcode may be accessed electronically, such as through the returns portal accessed via a recipient's mobile device. In one embodiment, a return portal may present an option for printing the return label at a shipping location of the logistics provider, and/or may provide an option for sending the return label via an electronic protocol (e.g., email, text, etc.), and/or may provide an option for printing the return label locally. Additionally, the return delivery information associated with the return label may be generated based on the parameters established by the shipper in the returns portal. For example, based on the shipper's unique identifier and the associated shipper-designated parameters, a service level of the return may be selected for the return label. Once a return label is accessed, the item(s) being returned can then be dropped off at a staffed or unstaffed drop-off location of the logistics provider (e.g., an access point, a logistics provider customer service center, etc.) or picked up by the logistics provider.

The utilization of pre-authorized returns and customizable return parameters may allow a shipper to reduce the resources required for return management, such as by reducing the cost associated with pre-printing and/or pre-preparing return labels for inclusion with items shipped to recipients. The pre-authorized return designation may also reduce customer service requests directed to the shipper from recipients by allowing the recipient to initiate a return and access the return label directly with the logistics provider. This return process may also allow for the capturing of customer feedback to provide improved customer service, sales, and/or product repair and/or restocking by the shipper. For example, information collected during the returns process may be used to direct returned items to appropriate return locations, such as designated repair facilities rather than back to a shipper when a repair is required that cannot be performed at the shipper's location. Pre-authorized returns may also be useful for the return of certain types of items, such as high-tech/high-value products, recyclable or reparable products, warranty repairs, executed legal or financial documents, test samples provided to labs, or other types of returned items.

### Processes that Enable Pre-Authorized Returns

In one embodiment of the present technology, a logistics provider may allow a shipper to designate a shipper's account number with the logistics provider, which is one example of a unique identifier, for pre-authorized returns, thereby allowing items sent to recipients using the account number to be eligible for pre-authorized return through the logistics provider. As discussed herein, a return portal allows the shipper to associate selected return parameters with the account number, such as a service level for returns (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and the like), a return eligibility period, a return destination, any information required from the recipient to initiate the return, and/or any other return parameters.

The initiation of a pre-authorized return may also generate email or other electronic communications and/or notifications that are selectively or automatically sent to designated parties (e.g., the shipper and/or the recipient). The communications and notifications may include a return confirmation, a return status, a location of items in transit, and/or a return receipt. Further, a tracking number may be sent for tracking the transit status of the returned item with the logistics provider.

In additional embodiments, the pre-authorized return status of an item may be determined based on an identifier associated with the item. For example, one identifier may be a Stock Keeping Unit (“SKU”) number or other product-specific designation associated with items being delivered/returned. Pre-authorized returns may therefore be configured for items on a more individualized basis to provide different return parameters for different items delivered to recipients. For example, different return parameters, such as return location, return eligibility, service levels, etc., may be appropriate for different types of items. For example, items of higher value may be designated for a higher service level of shipping for their return than lower value items, and/or items that cannot be re-stocked and re-sold by the shipper may be designated for return to a location other than the shipper.

Turning now to FIGS. 1-20, processes, workflows, systems, and network architectures configured to enable pre-authorized return of items in a logistics network are provided, in accordance with embodiments of the present technology. Referring initially to FIG. 1, a block diagram of an exemplary computing device 2 suitable for providing pre-authorized return of items in a logistics network is provided, in accordance with an embodiment of the present technology. It should be noted that although some components depicted in FIG. 1 are shown in the singular, they may be plural, and the components may be connected in a different, including distributed, configuration. For example, computing device 2 might include multiple processors and/or multiple radios. As shown in FIG. 1, computing device 2 includes a bus 18 that may directly or indirectly connect different components together, including memory 4, processor(s) 6, presentation component(s) 8 (if applicable), radio(s) 10, input/output (I/O) port(s) 12, input/output (I/O) component(s) 14, and power supply 16.

Memory 4 may take the form of the memory components described herein. Thus, further elaboration will not be provided here, but it should be noted that memory 4 may include any type of tangible medium that is capable of storing information, such as a database. A database may include any collection of records, data, and/or other information. In one embodiment, memory 4 may include a set of computer-executable instructions that, when executed, facilitate various functions or steps disclosed herein. These instructions will variously be referred to as “instructions” or an “application” for short. Processor 6 may actually be multiple processors that may receive instructions and process them accordingly. Presentation component 8 may include a display, a speaker, a screen, a portable digital device, and/or other components that can present information through visual, auditory, and/or other tactile cues (e.g., a display, a screen, a lamp, a light-emitting diode (LED), a graphical user interface (GUI), and/or even a lighted keyboard).

Radio 10 may facilitate communication with a network, and may additionally or alternatively facilitate other types of wireless communications, such as Wi-Fi, WiMAX, LTE, Bluetooth, and/or other VoIP communications. In various aspects, the radio 10 may be configured to support multiple technologies, and/or multiple radios may be configured and utilized to support multiple technologies.

Input/output (I/O) ports 12 may take a variety of forms. Exemplary I/O ports may include a USB jack, a stereo jack, an infrared port, a firewire port, and/or other proprietary communications ports. Input/output (I/O) components 14 may comprise one or more keyboards, microphones, speakers, touchscreens, and/or any other item useable to directly or indirectly input data into the computing device 2. Power supply 16 may include batteries, fuel cells, and/or any other component that may act as a power source to supply power to computing device 2 or to other components.

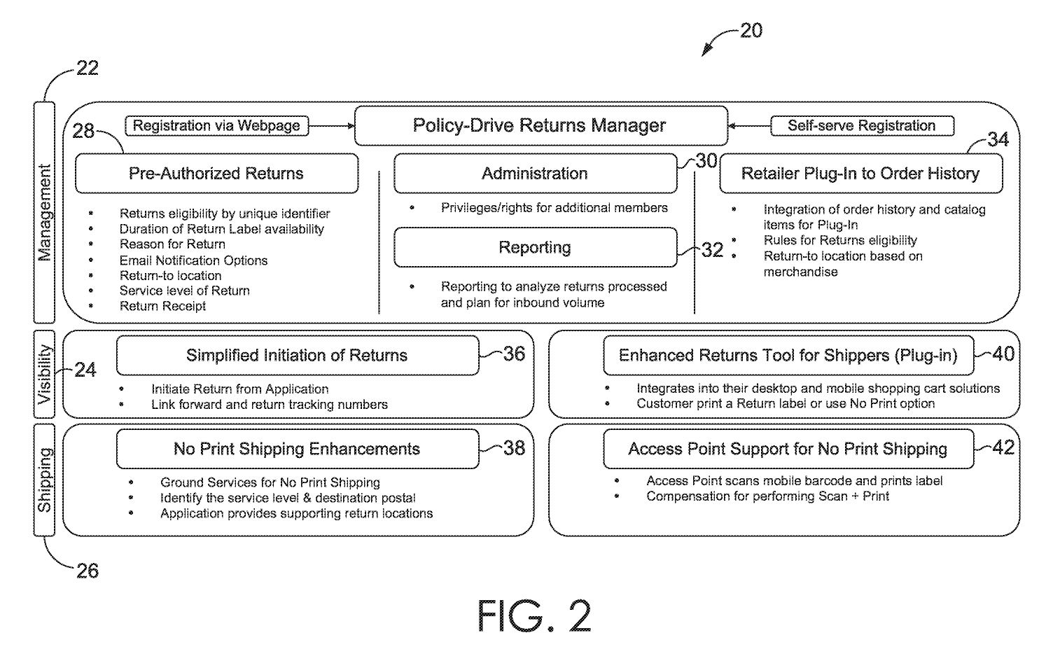

Referring now to FIG. 2, an example of a pre-authorized return process/workflow/system 20 that enables pre-authorized returns through a logistics provider is presented, in accordance with an embodiment of the present technology. FIG. 2 depicts three elements 22, 24, 26 in particular that collectively support pre-authorized returns. The management element 22 supports the registering of a shipper for pre-authorized returns. The management element 22 includes a pre-authorized returns portion 28 that allows a registered shipper to link pre-authorized returns eligibility with a unique identifier that is associated with the shipper (e.g., the shipper's account number with the logistics provider). The shipper can designate, for association with their unique identifier, requirements and/or parameters for initiating a return as listed in portion 28 of FIG. 2. This may include, for example, and as discussed elsewhere herein, a duration of return label availability (e.g., anywhere from 30-180 days), a reason for the return required from the recipient returning the item (e.g., the item is defective, no longer wanted, missed delivery date, etc.), email notification options (e.g., return tracking, notifications regarding delivery, refunds, shipping status, etc.), a designated return location (e.g., the shipper's location or another location, such as a repair facility), a service level of returns (e.g., a return shipping speed or method, such as ground or air), and/or return receipt generation. In some embodiments, the shipper may have multiple associated unique identifiers and may establish different requirements and/or parameters for each unique identifier.

The administration portion 30 can be used to set privileges and/or rights for additional members (e.g., granting access to certain persons or organizations, members, recipients of communications, etc., designated by an authorized person on the account). The reporting portion 32 includes aspects that analyze processed returns. The information associated with the reporting portion 32 may, for example, be used by the logistics provider to facilitate proper delivery, storage, and tracking of items being delivered and returned. Further, a statistical analysis of different aspects of the return process (e.g., number of returns, reasons for returns, return costs, etc.) may also be generated through the reporting portion 32. The retailer plug-in to order portion 34 includes aspects that integrate an order history and catalog items of a shipper into the pre-authorized returns system. The plug-in portion 34 may also support the establishing of return requirements/parameters for a shipper's pre-authorized return process, as discussed herein, and may be used to designate locations for the shipper's returns. For example, a shipper may designate locations for returns based on the return reason, and/or may designate the return locations based on the type of item(s) being returned. As an example, when a return reason indicates an item is defective or damaged, the item may be shipped to a repair facility, or may be shipped to a disposal location if the item cannot be repaired or resold by the shipper. Other location preferences are possible and contemplated herein.

The visibility element 24 includes aspects that support the pre-authorized return process. In particular, the visibility element 24 includes aspects for the simplified initiation of returns 36 and enhanced return tools for shippers 40 described herein. The shipping element 26 includes aspects for no-print shipping enhancements 38 (e.g., mobile/scannable barcode generation) and access point support for no-print shipping 42 (e.g., printing of shipping labels at shipping locations of the logistics provider using a mobile scannable barcode provided by a recipient). Referring now to the visibility element 24, the simplified initiation of returns aspect 36 and processes and systems thereof allows a recipient to initiate a return from an application such as, for example, a web or cloud-based return portal, which may also be provided through a mobile device application, or another application or interface.

The simplified initiation of returns aspect 36 also allows a logistics provider to generate and link a tracking/shipping number used to deliver an item with a tracking/shipping number used to return the item. In other words, a tracking/shipping number may be generated for the initial delivery of the item to a recipient, and a separate tracking/shipping number may generated for the pre-authorized return of the item (e.g., either initially when the item is shipped or when the return is initiated). These tracking/shipping numbers, associated with separate transfers of a common item, may be linked together in the logistics provider's system to allow the shipper and/or recipient to track the forward, or initial delivery, status of the item and the return status of the item. The tracking of the delivery and return status may be enabled with a common application, such as a web-based return portal accessible through the logistics provider's website.

The enhanced return tools for shippers aspect 40 represents a plug-in that integrates into various computer, software, and/or web-based applications associated with a shipper sending items that are pre-authorized for return. For example, the plug-in may be integrated into a retailer's website and/or mobile applications associated therewith so that products purchased via the website can be established for pre-authorized returns through the logistics provider used by the retailer. The plug-in may further be integrated into an online shopping cart application or other e-commerce purchasing solution on a retailer's website where products are purchased and shipping is initiated for delivery of purchased products.

The functionality provided by a pre-authorized return system and particularly the enhanced return tools for shippers aspect 40 may include generating return shipping information (e.g., related to the return, the item, the sender, the shipper, the logistics provider, and/or any other aspect related to the return) and generating a scannable return label, which may be presented with an option to print the return label locally (e.g., from a computer at which the return is initiated), an option to send the return label electronically, and/or an option to print the return label at a shipping location of the logistics provider.

To provide one example, a recipient of an item that is making a pre-authorized return can present an electronic scannable return label obtained through a returns portal at a shipping location of a logistics provider, and the logistics provider can then, using a mobile scanning device, scan the electronic label to create and print a physical shipping label for attachment to the item being returned. The generated shipping label may be one containing machine-readable indicia (e.g., a bar code) encoding the return delivery information for use by the logistics provider in routing the item to the selected return location. A return shipping label or similar identifying/routing implement may also be generated and/or applied to an item in other ways, such as by affixing, printing, and/or otherwise embedding or attaching it to the item that is being returned or to a packaging enclosing the same.

Referring to the shipping element 26, the no-print shipping enhancements aspect 38 is provided to establish shipping services used by the logistics provider (e.g., ground, air, etc.) for the pre-authorized returns. The no-print shipping enhancements aspect 38 also establishes locations that support no-print shipping, in addition to the service level and destination for returns. The computing applications and devices associated with the shipping element 26 may also store, present, and/or otherwise provide access to a selection of available shipping locations at which a recipient making a pre-authorized return can ship the item being returned (e.g., such a list may be provided through the returns portal discussed herein).

With continued reference to the shipping element 26, the no-print shipping aspect 42 is provided to establish shipping locations within the logistics network at which mobile bar code scanning can be performed to generate and print shipping labels for routing returned items to a desired return location. The no-print shipping aspect 42 also establishes support for transactions associated with pre-authorized returns via the logistics provider (e.g., providing billing information, accounting, and/or compensation to the shipping location for performing the intake, label generation and printing, and/or return routing).

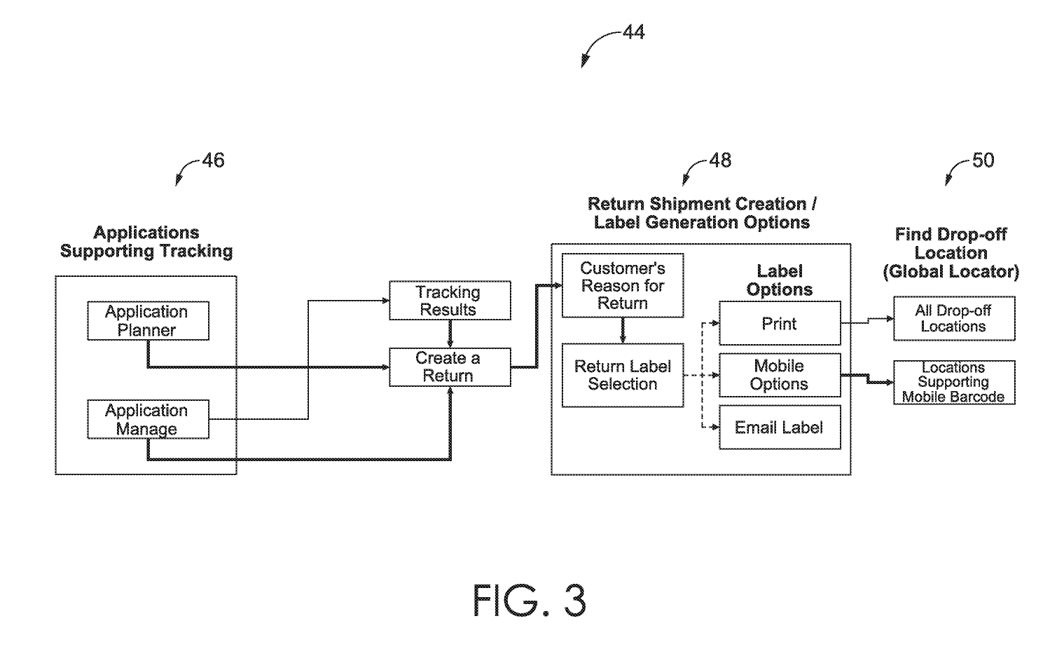

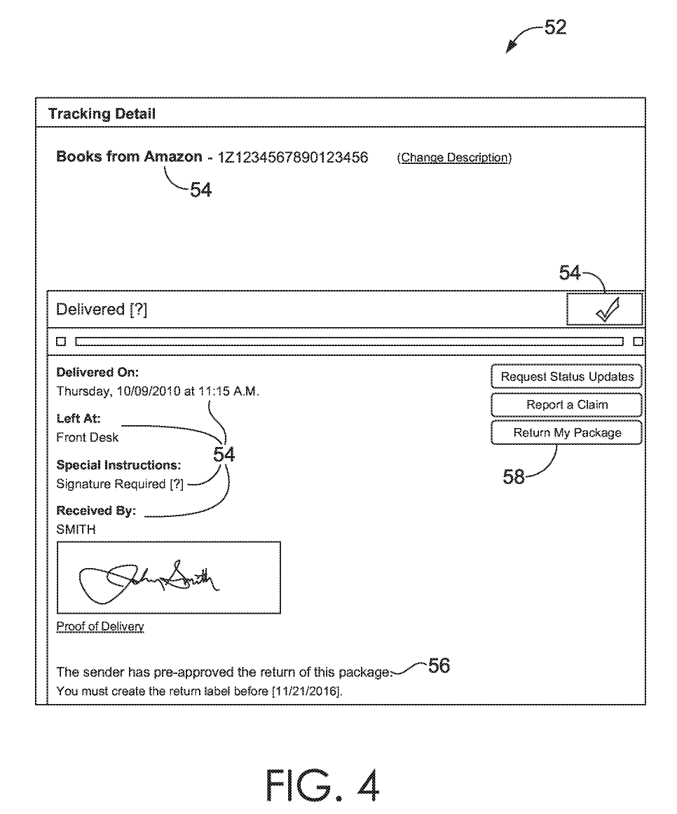

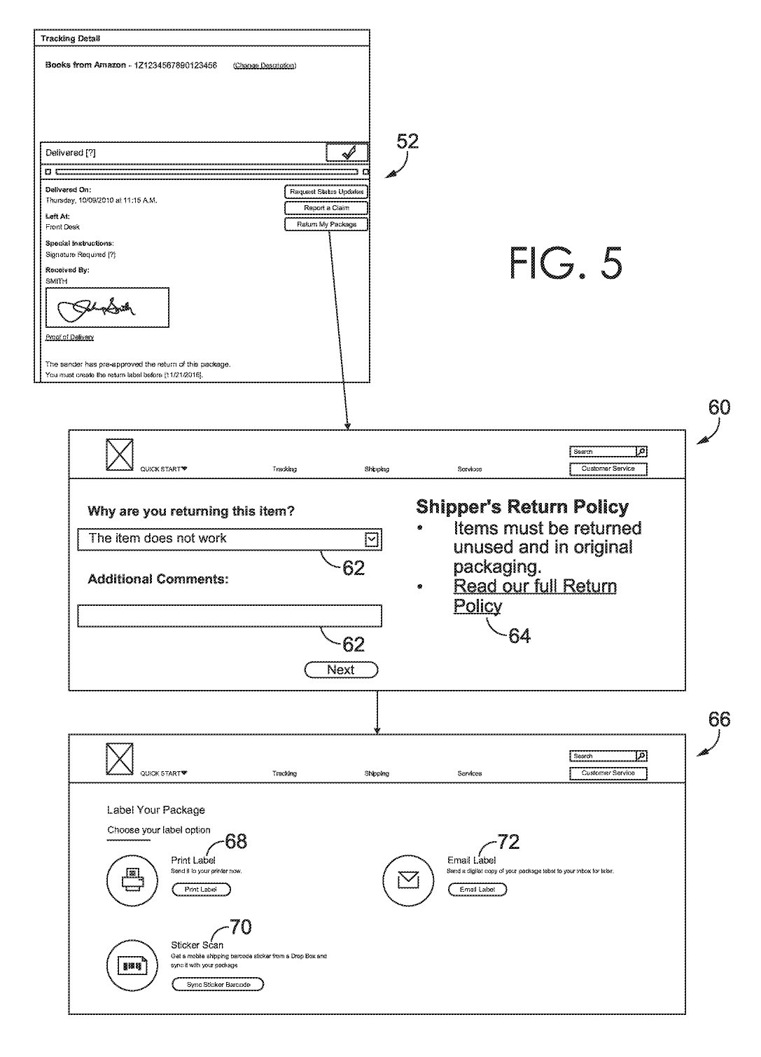

FIG. 3 is another example diagram of a process 44 for providing pre-authorized returns via a logistics provider, in accordance with an embodiment of the present technology. The process 44 includes an applications supporting tracking component 46 that, when integrated as one or more applications into one or more computing devices connected to a logistics network, allows for tracking of items, such as by shipping/tracking number, by a unique identifier associated with a shipper, and/or by an identifier associated with a shipped item (e.g., a SKU number). The component 46 also supports initiating a pre-authorized return. The process 44 further includes a return shipment creation and label generation options component 48 which obtains required information for a return and facilitates label generation for routing a returned item to a desired return location. For example, a pre-authorized returns portal provided by a logistics provider that is accessible by a recipient returning an item (see e.g., FIGS. 4-5 for one embodiment) may provide selectable options/inputs where a user may (or, if designated as required by the shipper for initiating a return, must) enter inputs to initiate a pre-authorized return. Such options/inputs may relate to a reason for the return, a number, weight, size, and/or other characteristics of item(s) being returned, comments or feedback, and/or other information related to the return.

Once the optional, or alternatively, required selectable inputs are received and processed, and the return policy parameters associated with a unique identifier of a shipper are satisfied, shipping label options are presented so that a shipping label can be generated and used to route the item to a desired return location. The return label generated and provided by component 48 may include options for printing the return label locally, presenting the return label electronically at a shipping location, and/or electronically sending the return label to a person returning the item. Finally, a Find Drop-off Location (Global Locator) component 50 allows for processing a pre-authorized return at one of the logistics provider's shipping locations. For example, available shipping locations may be stored, accessed, and/or presented to indicate where shipping of pre-authorized return items is possible in the logistics network. In this sense, some locations may support electronic shipping label/barcode processing. In such cases, a user returning an item via a pre-authorized return process may only need to present the electronic shipping label/barcode generated for the pre-authorized return at a selected shipping location, and then the shipping location can print and physically attach a label to the item or packaging enclosing the same to route the item to the return destination established by the shipper (e.g., based on a unique identifier associated with the shipper and the shipper's designated parameters associated therewith as described herein).

Referring now to FIGS. 4-13, various interactive webpages and display portions thereof, provided via a user-interface associated with a returns portal of a logistics provider, are shown, in accordance with embodiments of the present technology. FIG. 4 depicts one example of a return portal webpage 52. The return portal webpage 52 includes delivery/return information 54 for a particular shipped item (e.g. including a description of the item, a tracking number, delivery information, etc.) as shown in FIG. 4. The return portal webpage 52 further includes an indication 56 that the shipper has designated the delivered item as pre-authorized for return. In some embodiments, this information may not be presented visually on such a webpage, or may be presented upon a user initiating a return through the return portal webpage 52. The indication 56 also provides a date by which a return label must be created to initiate a return. The return portal webpage 52 further includes a return request button 58 used for initiating a pre-authorized return of the delivered item.

By enabling pre-authorized return of items through a return portal at a logistics provider's website, a recipient wanting to return an item may not be required to contact the shipper directly or use separate applications/processes to simply make a return that the shipper would have otherwise permitted. This saves time, resources, and improves efficiency of the returns process. It should be noted that as described herein, a returns portal may include one or multiple webpages, applications, and/or interactive components, and the webpages/displays shown in FIGS. 4-13 are intended to illustrate one example portal used for return shipment/pre-authorized return management.

FIG. 5 depicts how, once the return request button 58 is selected on the return portal webpage 52, the returns process is initiated, and a comments webpage 60 with selectable return inputs 62 is opened and presented. Comments webpage 62 also presents the return policy 64, or a portion thereof, established by the shipper that has permitted pre-authorized returns. Once any optional or required inputs (e.g., a reason for the return, etc.) have been received and processed, another webpage 66 is presented with labeling options 68, 70, 72 that allow for accessing a return label. Referring to the example provided in FIG. 5, labeling options webpage 66 includes an option 68 for printing locally, an option 70 for obtaining electronic shipping information (e.g., an electronic label or mobile barcode) for use in shipping a return item at a drop box or other shipping location of a logistics provider, and an option 72 for sending an electronic shipping label and/or mobile barcode via an electronic communication protocol (e.g., email, text message, Twitter®, Snapchat®, or another electronic communication protocol). It should be noted that option 72 shown in FIG. 5 references email, but the electronic communication protocol options listed above may also be provided in addition or in the alternative.

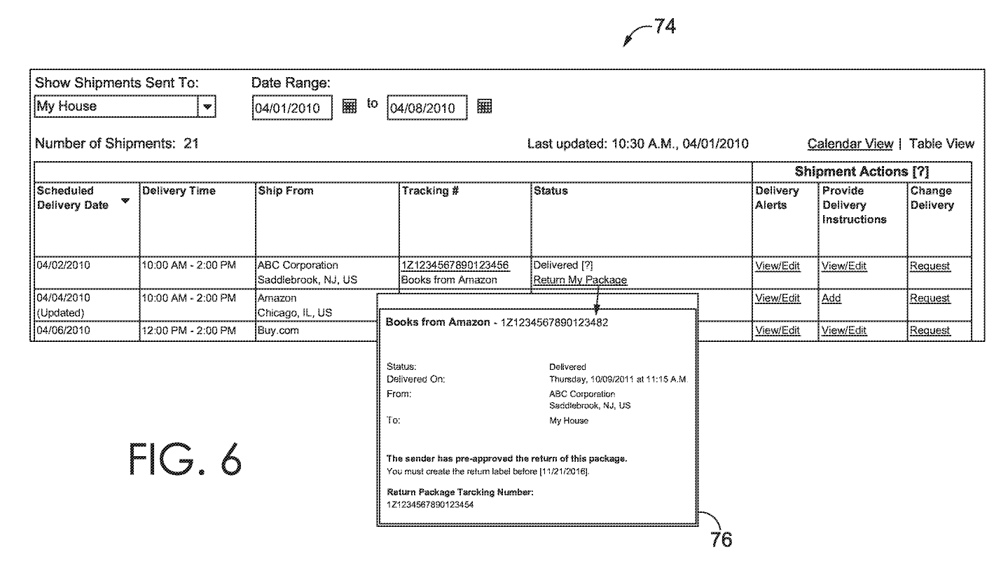

FIG. 6 depicts a tracking table 74 for a pre-authorized returns protocol, which may be accessible through a returns portal as described herein. The tracking table 74 includes information about items delivered to a user/destination and returns thereof. Further, as shown in FIG. 6, upon selecting a particular item to access delivery/return information for the item, a status webpage 76 is displayed with expanded information, which in the case of FIG. 6 includes information related to an initiated pre-authorized return. Specifically, the status webpage 76 depicted in FIG. 6 shows the return tracking number (which may be linked by the logistics provider to a delivery tracking number originally used to deliver the item), the status of the return, the delivery date, the recipient, and the pre-approval indication. Additional or alternative information may also be provided to a user and/or a shipper via the status webpage 76 for increased visibility and tracking during the returns process.

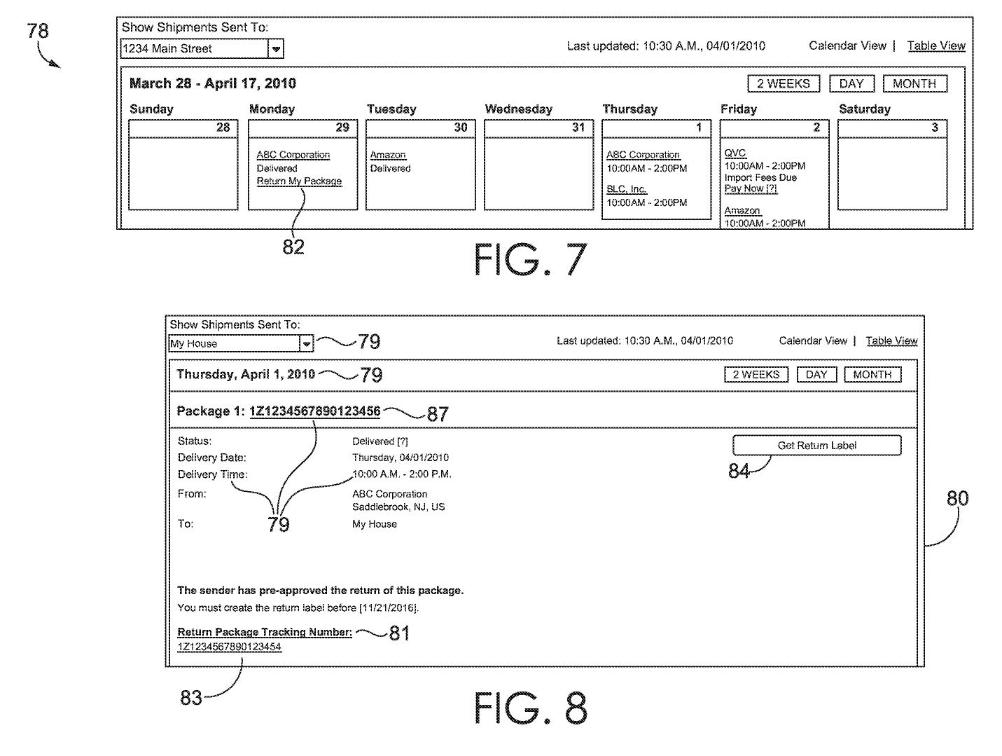

FIG. 7 depicts a calendar webpage 78 that provides access to information related to pre-authorized returns made through a return portal provided by a logistics provider, in accordance with an embodiment of the present technology. The calendar webpage 78 provides information related to shipments delivered to a particular location, including items/packages delivered, date of delivery, time of delivery, and also the status of returns, which in the case of the calendar webpage 78 shown in FIG. 7, includes pre-authorized returns. The calendar webpage 78 may be configured to display various ranges of time, including without limitation, one day, one week, two weeks, or a custom date range selected by the user. The embodiment of the calendar webpage 78 shown in FIG. 7, which may be integrated into a pre-authorized return system and/or return portal as described herein, provides further information about the shipments, including related return information, on a webpage 80 shown in FIG. 8 that is presented when an item in the calendar webpage 78 is selected and therefore expanded. FIG. 8 depicts webpage 80 providing detailed information 79 about a particular shipment 82 shown in the calendar webpage 78 provided in FIG. 7. The information 79 includes a delivery date and time, a delivery location, and an item tracking number. The webpage 80 also displays information 81 related to the shipper's policies for returns, including, as shown in FIG. 8, the policy for pre-authorized returns. The information 81 related to returns also includes a pre-established return tracking number 83, which may be linked with the delivery tracking number 87 via a shipper's unique identifier or another linking process used by the logistics provider. The webpage 80 further presents a button 84 for initiating a pre-authorized return and generating a return label for the same.

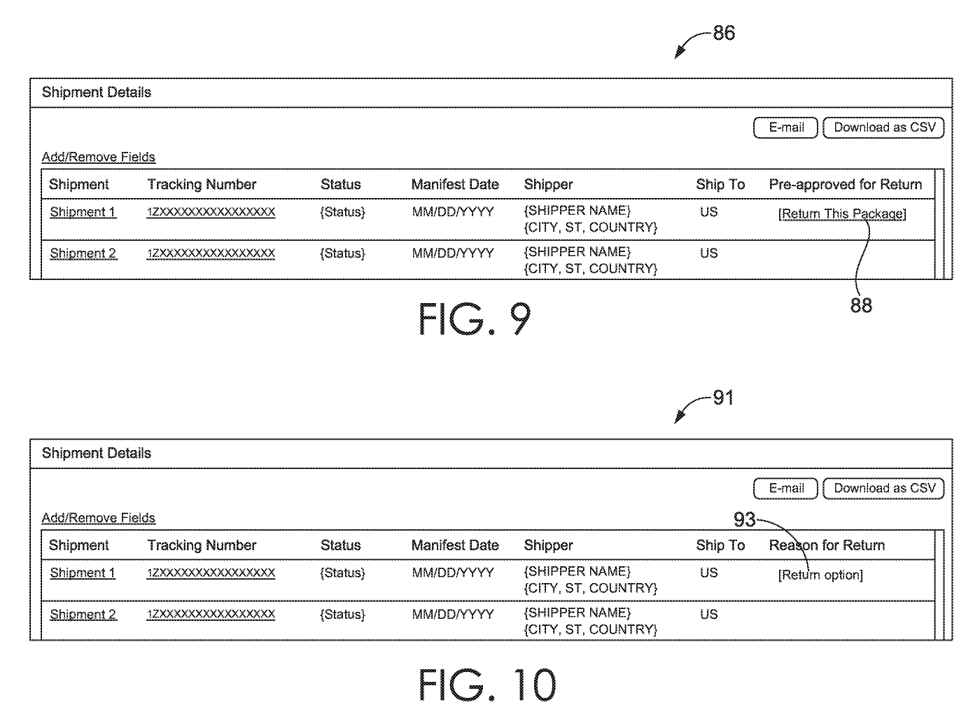

FIG. 9 depicts a shipping list view on a webpage 86 that may be presented/accessible via a returns portal provided through a logistics provider's website, in accordance with an embodiment of the present technology. The webpage 86 provides information about shipments made to a particular user at a particular location. This information includes a tracking number, a shipment status, a manifest date, a shipper from which the item(s) originated, and a shipping destination country. The webpage 86 also presents a selectable input 88 next to one of the shipments with items that are pre-authorized for returns, allowing a pre-authorized return to be initiated for the items through the logistics provider. FIG. 10 depicts a modified version 91 of the webpage 86 shown in FIG. 9, after the selectable input 88 associated with shipment 1 has been activated to initiate a return of an item or items associated with shipment 1. The modified version 91 of the webpage 86 shows a selectable input 93 that can be used by a recipient to provide a reason for the return.

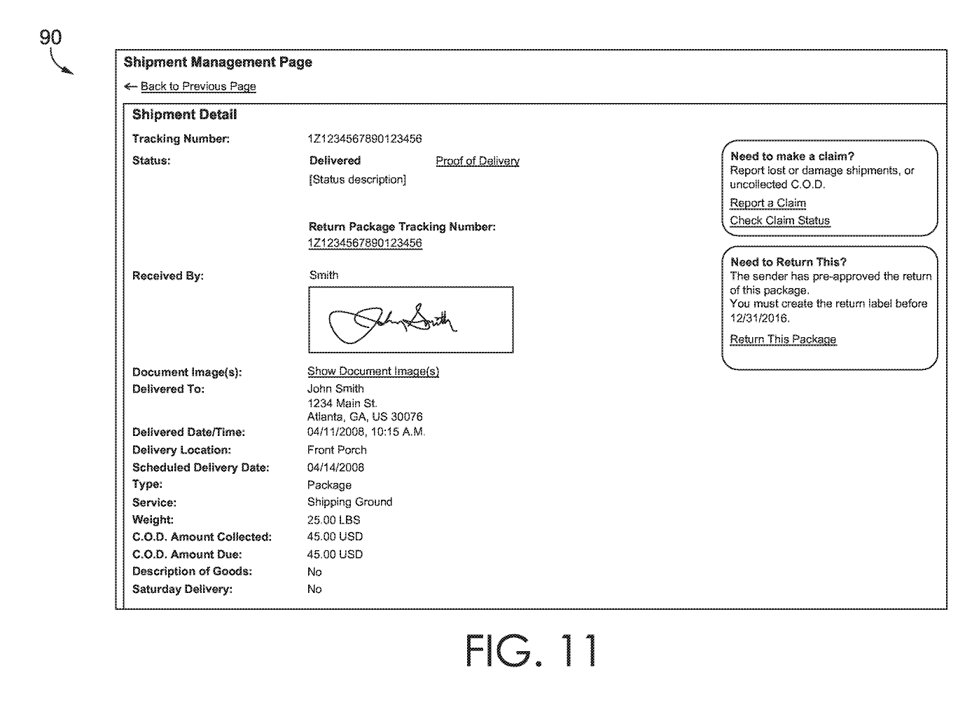

FIG. 11 depicts a shipping detail perspective of a shipment management page 90 associated with a pre-authorized returns portal as described herein, in accordance with an embodiment of the present technology. The shipment management page 90 includes a variety of information about a shipped item. This information includes a tracking number for the delivered item and also a return tracking number that is used for a pre-authorized return of the item, as well as a status description, a delivery address, an indication that pre-authorized returns are enabled, and other information and hyperlinks routing to additional pages with additional information and functionality (shown in underline text).

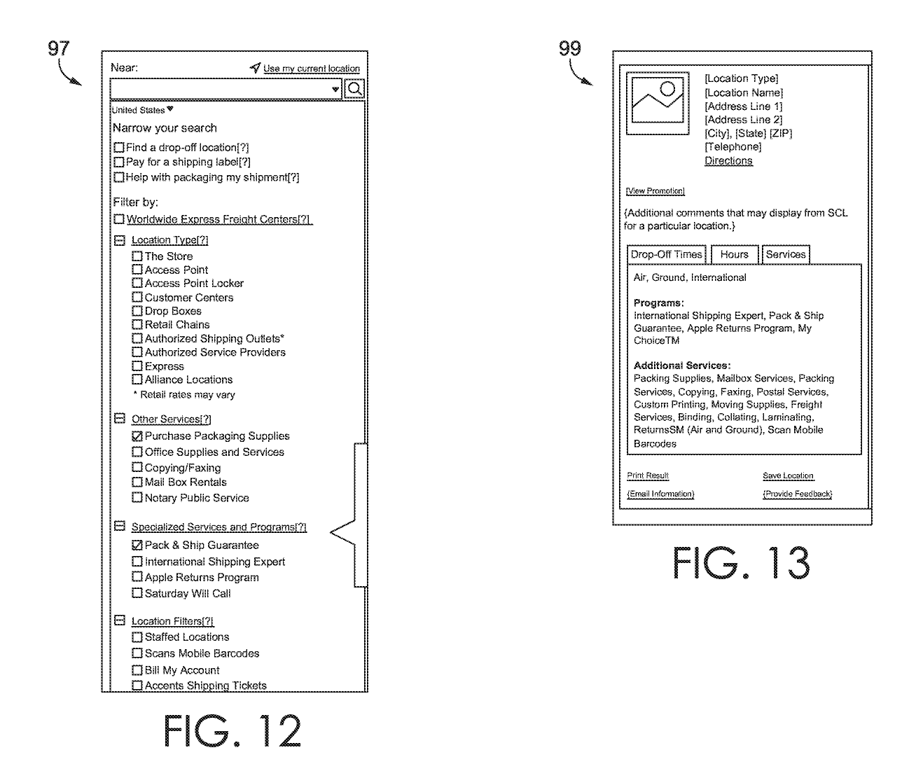

FIGS. 12-13 depict user-interface webpages 97, 99 that relate to the selection of a drop-off location for an item being returned via a pre-authorized returns process as described herein, in accordance with an embodiment of the present technology. These user-interface webpages 97, 99 may be accessed through hyperlinks presented on webpages/display pages of a return portal or may be provided in response to a recipient initiating a return through a webpage, such as the shipment management page 90 shown in FIG. 11. As a further example, upon being presented with the webpage 66 shown in FIG. 5, and upon selecting a labeling option 68, 70, or 72, a recipient making a return may be presented with the user-interface webpages 97, 99, or with a page that contains hyperlinks to user-interface webpages 97, 99.

Turning to FIG. 12, webpage 97 presents a list of available shipping locations and search criteria for sorting the same. Once a user has initiated a pre-authorized return for a delivered item, a selection of locations for shipping the item via the logistics provider is presented on webpage 97, so that a recipient returning the item can make a selection or at least locate a suitable shipping location for dropping off the item. Webpage 99 shown in FIG. 13 provides information about a selected shipping location located through the webpage 97. Webpage 99 provides detailed information about the selected location (not all of which is populated in FIG. 13). This location-specific information may include available hours of operation, services, shipping methods that are available (e.g., ground or air, etc.) and other information about the selected shipping location.

FIGS. 14-17 depict various webpages of a returns portal 94 presented via a user interface 92, which may be accessed through a logistics provider's website and/or mobile applications, in accordance with embodiments of the present technology. The information presented on the user-interface 92 shown in FIG. 14 is tailored to allow a shipper to easily manage the parameters and settings of the shipper's pre-authorized returns process. In particular, the rules and settings display 96 shown on the user-interface 92 in FIG. 14 includes selectable inputs (e.g., “returns settings,” “services settings,” and “return to address”). Each of these inputs, when selected, generates a corresponding display on the right side of the user-interface 92. The display provides selectable inputs that can be used to adjust parameters and settings of the shipper's pre-authorized returns. As shown in FIG. 14, return settings, services settings, and return to addresses options are selectable in the rules and settings display 96. Further, options for the return portal dashboard, administrative details, returns, notifications, and plugins are also provided on the user-interface 92 in addition to the rules and settings display 96 for selection and interaction.

FIG. 14 shows the user-interface 92 of the return portal 94 being presented with the “return settings” option 98 selected in the “rules and settings” display 96 portion of the user-interface 92. This selection generates, on the right side of the user interface 92, a “return policy account settings” display 100 that includes a selectable input 101 (which in the embodiment of FIG. 14 is a drop-down menu) that allows a shipper to select a shipping account (e.g., account number) which may be the shipper's unique identifier that is associated with items that are pre-authorized for return. In this sense, selecting an option in the “rules and settings” display 96 generates an interactive display (e.g., the display 100) that accompanies the display 96 to allow modification of the parameters associated with the selection.

Further, as shown in FIG. 14, the “return policy account settings” display 100 further includes a selectable input 102 that can be used to enable or disable pre-authorized returns for items delivered by a logistics provider in association with the selected shipping account (e.g., account number). The user-interface 92 further includes a selectable input 104 that allows a shipper to select or set a maximum time that a recipient is allowed to initiate a pre-authorized return and/or generate a return label after an item is delivered in association with the selected shipping account. As shown in FIG. 14, the selectable input 104 allows the user to specify a particular time period (e.g., 30 days) or provide an unlimited time period for returns.

FIG. 15 depicts another display 106 which may be presented with or separately from the display 100 along with the rules and settings display 96 when the “return settings” option 98 shown in FIG. 14 is selected. The display 106 may further be presented, in other embodiments, by clicking on a hyperlink on the display 100, or otherwise continuing to an additional page of the return portal 94. The display 106, in the example provided in FIG. 15, allows a shipper to establish additional return parameters described further herein below. It should be noted that in general, selecting an option in the rules and settings display 96 provides a corresponding display on the right side of the user-interface 92. Display 106 is generated and presented to allow a shipper establishing parameters for their pre-authorized returns process to designate whether to request and/or require reasons for making the return. The page 106 presents a selectable input 108 that, when selected, solicits a “reason for return” from a recipient initiating a pre-authorized return. The page 106 also includes a selectable input 110 that, when selected, makes a reason for initiating the return required. The page 106 also includes selectable inputs 112 that allow a shipper to choose which of the reasons for return are presented to a recipient for selection when making a pre-authorized return. The page 106 further includes a selectable input 113 for enabling comment collection from a recipient making a pre-authorized return. In other words, when the selectable input 113 is activated, a box soliciting comments will be presented to the recipient during the returns process.

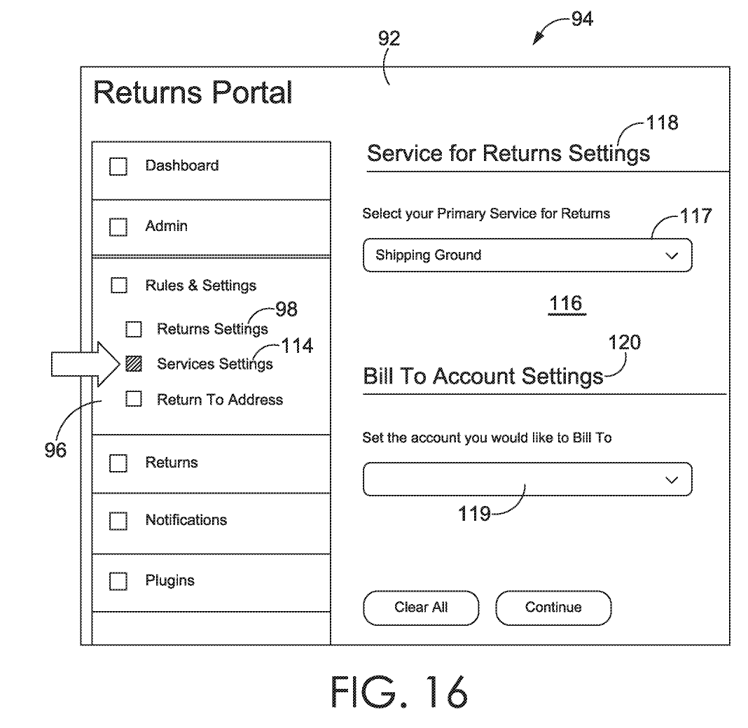

FIG. 16 depicts a portion of the user-interface 92 of the return portal 94 shown in FIG. 14 with the “services settings” option 114 selected instead of the “return settings” option 98 selected as shown in FIG. 14. As a result, a display 116 is generated and presented on the right side of the user-interface 92 along with the “rules and settings” display 96. The display 116 includes a “Services and Returns Settings” portion 118 with a selectable input 117 provided to allow a shipper to select a service level of shipping for pre-authorized returns. In the example display 116 shown in FIG. 16, ground shipping is selected, but other shipping options may be available and selectable. For example, options for multiple shipping speeds may be available. The display 116 also includes a “Bill to Account Settings” portion 120 that includes a selectable input 119. The selectable input 119 is provided so that a shipper can designate a shipping account, which may be associated with a unique identifier (e.g., a shipping account number with a logistics provider), for billing the shipping costs of any pre-authorized returns made on the account.

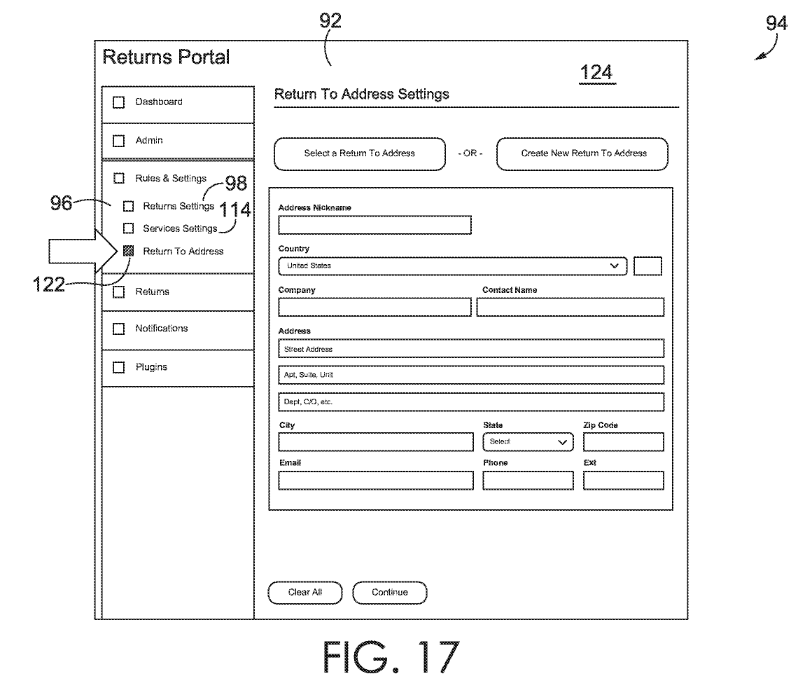

FIG. 17 depicts the user-interface 92 of the return portal 94 showing the “return to address” option 122 of the “rules and settings” display 96 selected. As a result, a display 124 is generated and presented on the right side of the user-interface 92 that allows a shipper to select or create a return address for items returned using the pre-authorized returns process. The address may be associated with the shipper's unique identifier (e.g., shipping account number) to facilitate efficient returns to a desired location via the logistics provider associated with the returns portal 94. It should be noted that multiple return addresses may be entered and used in some embodiments, and also may be selected and/or used based on a reason for return as discussed herein. As shown in FIG. 17, the display 124 includes a variety of modifiable inputs for nicknames, address information, email, and other information.

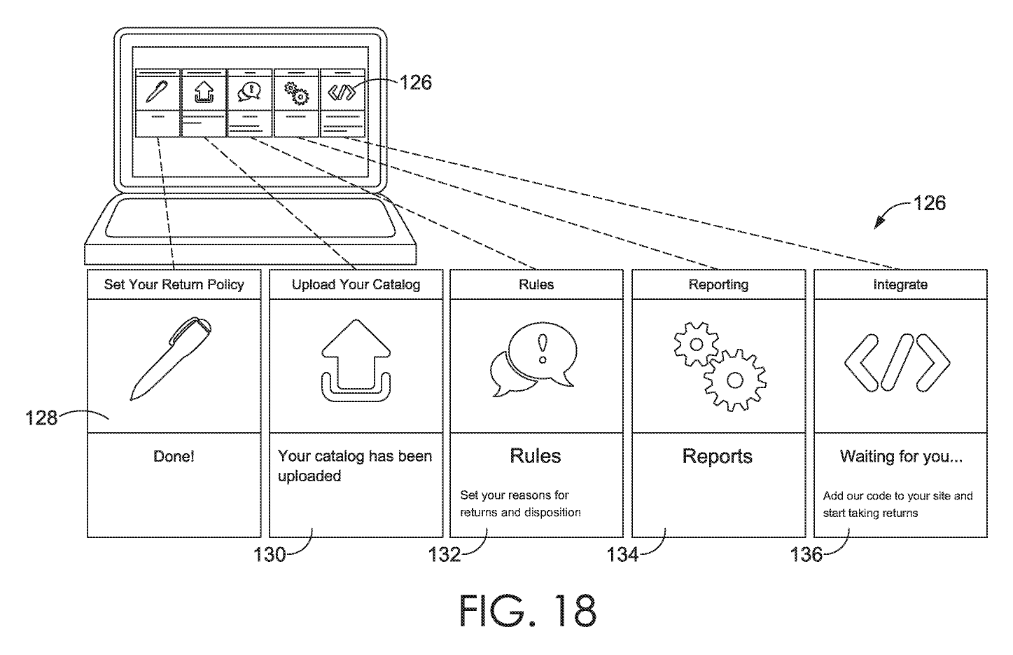

FIG. 18 depicts an example user-interface 126 that presents a variety of selectable options that are accessible by a shipper for use in establishing pre-authorized returns with a logistics provider, in accordance with an embodiment of the present technology. Input selections 128, 130, 132, 134, and 136 will now be discussed in detail. Input selection 128 allows a shipper to select their return policy with the logistics provider, such as, for example, individually authorized returns or pre-authorized returns as described herein. Input selection 130 allows a shipper to upload their catalog of products to the logistics provider's applications and/or services. In this respect, uploading a shipper's catalog allows a list of items available from the shipper (e.g., products for sale) to be identifiable for the purposes of pre-authorized returns through the logistics provider. The catalog information may be used to link the shipper's items to the shipper's unique identifier to establish them for pre-authorized returns, and/or may be used to establish an individual identifier for each item or groups of items in the catalog to identify the item or groups of items as designated for pre-authorized returns. For example, item identifiers may include a SKU, product name, product category, or other identifier that can be used to determine if an item or group of items in a selection is designated for pre-authorized returns. Further, uploading and linking a catalog of the shipper's items may allow for different items in the catalog (e.g., designated by SKU, or other identifiers) to be associated with different pre-authorized return parameters. For example, a product having a certain SKU may be designated for pre-authorized return to one location based on the SKU's assigned return location parameter, and another product having another SKU may be designated for return to another location based on that SKU's assigned return location parameter (established by the shipper). As another example, the SKU of one product may designate return to the shipper, and the SKU of another product may designate return to a disposal facility if the product cannot be re-stocked and re-sold by the shipper.

Input selection 132 allows a shipper to go to a user-interface, such as the user-interface 92 shown in FIG. 14, to establish rules and settings for pre-authorized returns associated with a particular account the shipper has with the logistics provider (e.g., determined by the aforementioned described unique identifier). Input selection 134 allows a shipper to access reports (e.g., data, statistics, tracking information, etc.) related to returns and/or deliveries made using their shipping account. Input selection 136 provides an option for the shipper to integrate the logistics provider's services into the shipper's website or other computing and mobile applications.

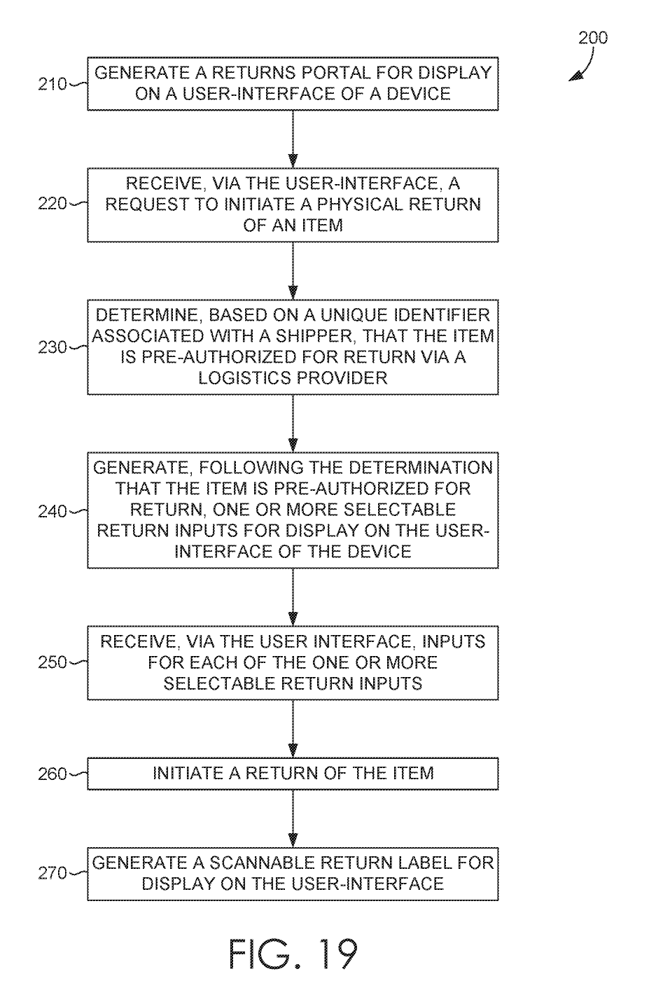

FIG. 19 depicts a block diagram of an example process 200 for enabling and/or providing pre-authorized return of items via a logistics provider, in accordance with an embodiment of the present technology. At block 210, a returns portal is generated for display on a user-interface of a device. The return portal may present similar interactive pages and elements to those described herein, such as return portal webpage 52 shown in FIGS. 4-5. The returns portal may also, in embodiments, present information about an item delivered to a recipient via a logistics provider and may present at least one return policy of a shipper from which the item originated, such as, for example, as shown in the return portal webpage 52 depicted in FIGS. 4-5. The return portal may display delivery information including a location. The return portal may indicate that a return of an item is pre-authorized. The pre-authorization of returns may be based on settings linked to a unique identifier associated with the shipper of the item (e.g., an account number that is designated for pre-authorized returns, as discussed with respect to FIGS. 14-17). The return portal may present the return policy or at least a portion of the information thereof in the return portal or pages thereof.

At block 220, a request to initiate a physical return of the item to the shipper is received. The return request may be made by selecting an option to initiate a return via a selectable input in the return portal, such as, for example, the return request button 58 shown in FIG. 4. The return portal may solicit or require information related to the return, such as a reason for the return, a number or selection of items being returned, comments, or other inputs, as discussed herein. The return portal may also provide a return shipping number, which may be linked to a shipping number used to originally deliver the item being returned.

At block 230, the item is determined, based on a unique identifier associated with the shipper (e.g., a shipping account number), to be pre-authorized for return via the logistics provider. The determination that the item is pre-authorized for return may be made based on the unique identifier being associated with a tracking/shipping number of the original delivery of the item, or based on an identifier of the item itself. For example, when a shipper sends an item, it may be determined based on an identifier associated with the product (e.g., a SKU) that the item is pre-authorized for returns. Accordingly, when a return is initiated, the shipping information (e.g., tracking number) and/or item information (e.g., SKU) may be used to determine an association with the unique identifier, which may be used to determine that pre-authorized returns are enabled for the item. As another example, the logistics provider may assign the unique identifier to the item being returned based on the item being part of the catalog of the shipper that is designated for pre-authorized returns. Alternatively, when a return is initiated, the request for the return provided by the recipient may include information that was provided with the original shipment of the item, such as the unique identifier or other information that is associated with the unique identifier, indicating the shipment is designated for pre-authorized returns.

A return may be made to the shipper or to another location. The unique identifier may link the shipper's designations for pre-authorized returns with the item. The unique identifier may allow the pre-authorized return status to be determined, shipping labels to be generated based on the shipper's account with the logistics provider, and/or may be used for billing the shipper for the return services, among other possible uses.

At block 240, one or more selectable return inputs are generated for display on the user-interface of the device following the determination that the item is pre-authorized for return. The one or more selectable return inputs may be designated by the shipper and may be associated with the unique identifier as discussed herein. Further, the selectable return inputs may be determined from the unique identifier associated with the shipper to provide inputs that correspond to the shipper's established parameters for pre-authorized returns.

At block 250, inputs are received, via the user interface, for each of the one or more selectable return inputs. For example, a user may select, if solicited or required to make a selection, a reason for return via the return portal. At block 260, a return of the item is initiated. Initiating the return may result in a return tracking number associated with the item being generated or being made active if already generated for use by the logistics carrier in routing the item to a desired return destination. Further, an electronic barcode, designator, or shipping label may be created.

At block 270, a scannable return label is generated for display on the user-interface. The scannable return label may include return information associated with the item and the shipper. For example, the return label may comprise or originate from an electronic mobile barcode or designator used for accessing, printing, and/or sending a shipping label used for routing the item back to the shipper or to another return location. The process may further include receiving the scannable return label or an electronic version thereof at a shipping location of a logistics provider, scanning the label using a mobile barcode scanner, printing and attaching the label to the item, and routing the item, using the shipping label and the return tracking number associated therewith, back to the shipper or to another return location.

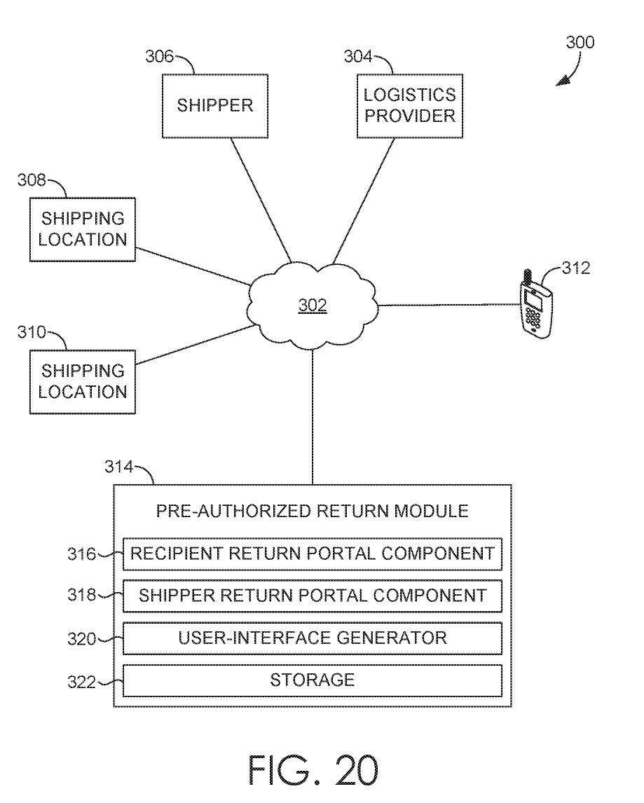

Referring to FIG. 20, an example system 300 that is suitable for supporting pre-authorized return of items via a logistics provider is shown, in accordance with an embodiment of the present technology. In FIG. 20, the system 300 includes a network 302, which may be connected via a wired and/or wireless communication protocol that communicatively couples one or more network components, computing devices, and/or applications associated with a logistics provider 304 that delivers items to selected locations, a shipper 306 that ships items to locations via the logistics provider 304, shipping locations 308, 310 that are associated with the logistics provider 304 and that are configured to support the receiving and routing of items, such as from the shipper 306, a device 312 associated with a recipient that may present a user-interface, and which may be a mobile computing device or may be an application accessed through a network and/or the internet, and a pre-authorized return module 314. The pre-authorized return module 314 may include a number of components that support the system 300 and processes for providing pre-authorized return of items via the logistics provider 304. For example, as shown in FIG. 20, the module 314 includes a recipient return portal component 316 that is configured to generate a return portal and features thereof for access by a recipient of an item that uses the device 312 to facilitate pre-authorized return of the item to the shipper 306 via the logistics provider 304 as described herein. The module 314 further includes a shipper return portal component 318 that is configured to generate a return portal and features thereof for access by the shipper 306 to establish, maintain, and modify the shipper's pre-authorized returns policies with the logistics provider 304 as described herein. The module 314 further includes a user-interface generator 320, which may be used in conjunction with the recipient and shipper return portal components 316, 318 to support the generation of corresponding return portals on user-interface displays, as well as webpages and applications thereof. The module 314 further includes a storage 322 for storing information related to the recipient and/or to the shipper, such as preferences, history, and/or settings, and/or other data related to pre-authorized returns, and related accounts and activity. The storage 322 may include one or more storage media and/or hardware.

The present technology has been described in relation to particular embodiments, which are intended in all respects to be illustrative rather than restrictive. Alternative embodiments will become apparent to those of ordinary skill in the art to which the present technology pertains without departing from its scope. Different combinations of elements, as well as use of elements not shown, are possible and contemplated herein. It will be understood that certain features and sub-combinations are of utility and may be employed without reference to other features and sub-combinations. This is contemplated by and is within the scope of the claims.

What is claimed is:

1. A system that enables pre-authorized return of items delivered to a recipient by a logistics provider, the system comprising:
one or more computing devices connected to a network, the one or more computing devices comprising one or more processors and one or more non-transitory computer-readable media having computer-executable instructions stored thereon that, when executed by the one or more processors, perform a method comprising:
generating a returns portal for display on a user-interface of a device, the returns portal comprising information about an item delivered to the recipient via the logistics provider and at least one return policy of a shipper from which the item originated;
receiving, via the user-interface, a request to initiate a physical return of the item;
determining, based on a unique identifier associated with the shipper, that the item is pre-authorized for return via the logistics provider;
following the determination that the item is pre-authorized for return, generating one or more selectable return inputs for display on the user-interface of the device, wherein the one or more selectable return inputs are designated by the shipper and are associated with the unique identifier;
receiving, via the user interface, inputs for each of the one or more selectable return inputs;
initiating a return of the item following a determination that the received inputs for the one or more selectable return inputs satisfy requirements of the at least one return policy; and
generating a scannable return label for display on the user-interface, the scannable return label including return information associated with the item and the shipper.

2. The system of claim 1, wherein the return information further comprises the unique identifier associated with the shipper, and wherein the shipper comprises a merchant and the item comprises merchandise sold by the merchant.

3. The system of claim 1, further comprising a mobile barcode scanner, wherein the scannable return label is an electronic return label that is scannable by the mobile barcode scanner at a shipping location of the logistics provider to generate a physical shipping label for routing the item to the shipper or to another location.

4. The system of claim 1, wherein the unique identifier is associated with shipper-designated parameters for a return that include at least one of a service level for returns, an eligibility period for returns, and information required from the recipient for initiating returns.

5. The system of claim 1, wherein the method further comprises linking a first shipping number used for delivery of the item to the recipient with a second shipping number used for return of the item based on the unique identifier.

6. The system of claim 1, wherein the determination that the item is pre-authorized for return is further based on a Stock Keeping Unit (SKU) number associated with the item.

7. The system of claim 1, wherein the method further comprises presenting, on the user-interface, options to print the scannable return label, send the scannable return label via an electronic protocol, and print the scannable return label at a shipping location operated by the logistics provider.

8. The system of claim 1, wherein the selectable return inputs comprise a reason for initiating the return, and wherein a location to which the item is returned is based at least in part on the reason for initiating the return.

9. The system of claim 1, wherein the return information comprises a return destination that is selected based on return parameters established by the shipper that are associated with at least one of the unique identifier and an identifier associated with the item.

10. A computer-implemented method for enabling pre-authorized return of items delivered to a recipient by a logistics provider, the method comprising:
generating a returns portal for display on a user-interface of a device, the returns portal comprising information about an item delivered to the recipient via the logistics provider and at least one return policy of a shipper from which the item originated;
receiving, via the user-interface, a request to initiate a physical return of the item;
determining, based on a unique identifier associated with the shipper, that the item is pre-authorized for return via the logistics provider;
following the determination that the item is pre-authorized for return, generating one or more selectable return inputs for display on the user-interface of the device, wherein the one or more selectable return inputs are designated by the shipper and are associated with the unique identifier;
receiving, via the user interface, inputs for each of the one or more selectable return inputs;
initiating a return of the item following a determination that the inputs satisfy requirements of the at least one return policy; and
generating a scannable return label for display on the user-interface, the scannable return label including return information associated with the item and the shipper.

11. The computer-implemented method of claim 10, wherein the return information comprises the unique identifier associated with the shipper, and wherein the scannable return label is generated to include a machine-readable indicia that, when scanned, generates at least a portion of the return information.

12. The computer-implemented method of claim 10, wherein the unique identifier is associated with shipper-designated parameters for returns that comprise at least one of a service level for returns, an eligibility period for returns, and information required from the recipient for initiating returns.

13. The computer-implemented method of claim 10, further comprising linking a first shipping number used for delivery of the item to the recipient with a second shipping number used for return of the item based on the unique identifier.

14. The computer-implemented method of claim 10, wherein the at least one return policy comprises information about a return eligibility period.

15. The computer-implemented method of claim 10, wherein the return information comprises a return destination that is selected based on at least one of the unique identifier and an identifier associated with the item.

16. One or more non-transitory computer-readable media having computer-executable instructions stored thereon that, when executed by one or more processors of a computing device, perform a method that enables pre-authorized return of items delivered to a recipient by a logistics provider, the method comprising:
generating a returns portal for display on a user-interface of a device, the returns portal comprising information about an item delivered to the recipient via the logistics provider and at least one return policy of a shipper from which the item originated;
receiving, via the user-interface, a request to initiate a physical return of the item;
determining, based on a unique identifier associated with the shipper, that the item is pre-authorized for return via the logistics provider;
following the determination that the item is pre-authorized for return, generating one or more selectable return inputs for display on the user-interface of the device, wherein the one or more selectable return inputs are designated by the shipper and are associated with the unique identifier;
receiving, via the user interface, inputs for each of the one or more selectable return inputs;
initiating, based on the unique identifier, the received inputs, and the at least one return policy, a return of the item; and
generating a scannable return label for display on the user-interface, the scannable return label including return information associated with the item and the shipper.

17. The one or more non-transitory computer-readable media of claim 16, wherein the unique identifier is associated with shipper-designated parameters for a return that comprise at least one of a service level for returns, an eligibility period for returns, and information required from the recipient for initiating returns.

18. The one or more non-transitory computer-readable media of claim 16, wherein the method further comprises linking, based on the unique identifier, a first shipping number used for delivery of the item to the recipient with a second shipping number used for return of the item to the shipper or to another location.

19. The one or more non-transitory computer-readable media of claim 16, wherein the method further comprises presenting, on the user-interface, options to print a return shipping label locally, send the return shipping label via an electronic protocol, and print the return shipping label at a selected shipping location of the logistics provider.

20. The one or more non-transitory computer-readable media of claim 16, wherein the return information comprises a return destination that is selected based on shipper-designated parameters for returns that are associated with at least one of the unique identifier and an identifier associated with the product.
